(19) United States
(12) Patent Application Publication
(10) Pub. No.: US 2024/0381895 A1
(43) Pub. Date: Nov. 21, 2024

(54) FRUIT-CONTAINING CONFECTIONS

(71) Applicant: Wm. Wrigley Jr. Company, Chicago, IL (US)

(72) Inventors: David R. PHILLIPS, Chicago, IL (US); Thiruvenkadam VISWANATHAN, Chicago, IL (US); Kevin B. BRODERICK, Chicago, IL (US)

(21) Appl. No.: 18/692,450

(22) PCT Filed: Sep. 19, 2022
(86) PCT No.: PCT/US2022/043957

§ 371 Date: Mar. 15, 2024

Related U.S. Application Data
(60) Provisional application No. 63/245,969, filed on Sep. 20, 2021.

(51) Int. Cl. A23G 3/48; A23G 3/42

(52) U.S. Cl. CPC A23G 3/48; A23G 3/42

(57) ABSTRACT

Provided herein are fruit-containing confections comprising an intermediate-moisture fruit present and a binding agent, wherein the intermediate-moisture fruit has a moisture content of about 10 wt % to about 30 wt %, based on the total weight of the intermediate-moisture fruit. Also provided are methods of making the fruit-containing confections.

### BACKGROUND

Increased health awareness has led to increased consumption of fresh fruits and vegetables as a snack food. Real fruit-based snacks are a growing product category in the marketplace. However, fresh fruits and vegetables are seasonal, and undergo fairly rapid spoilage. Furthermore, certain fresh fruits, such as mango, are not easy to consume as a snack food, especially by children.

Although fruit and vegetable-based snack foods having extended shelf lives are commercially available, these typically possess unwanted additives (e.g., added sugars, artificial sweeteners and colors, etc.). Additionally, these snack foods are often subjected to process conditions, such as high heat for cooking and/or sterilization, that can significantly change their natural organoleptic profile (e.g., flavor, aroma, appearance, nutritional value, etc.). These changes can negatively impact consumer appeal.

Products containing a high amount of fruit ingredients are desirable. However, adding a high amount of fruit (20-60% of product by weight) as dried powder increases the hygroscopicity of the product, resulting in brittle products and hard texture. Using fully dried fruits in product can create texture and taste issues as well. Using fruits with a significant moisture content can overcome the issues seen with fully dried fruits, but also presents technical challenges. In particular, the moisture and water activity in products containing fresh fruit or partially dried (e.g., intermediate moisture) fruit is higher than in typical confections, which affects the product stability (e.g., microbial stability, flavor, and texture).

There is a need for a fruit-based confection that is stable under ambient conditions while possessing many of the appealing attributes or features of the fruit from which it is derived.

### SUMMARY

Provided herein are fruit-containing confections comprising: an intermediate-moisture fruit present in an amount of about 20 wt % to about 80 wt %, based on the total weight of the fruit-containing confection; and a binding agent, wherein the intermediate-moisture fruit has a moisture content of about 10 wt % to about 30 wt %, based on the total weight of the intermediate-moisture fruit. In particular embodiments, the fruit-containing confections disclosed herein have no added sugars. In particular embodiments, the binding agent has no added sugars. Also provided are methods of making fruit-containing confections comprising intermediate-moisture fruit.

### BRIEF DESCRIPTION OF THE FIGURES

FIG. 1 shows the water activity of fruit-based confection stored in ambient conditions (25 C and 50% RH). Water activity of 0.62 is considered to be high risk for microbial activity (mold growth). Apple-only samples (#5, top line) show increasing water activity over time and approaching the critical threshold of 0.62. Without wishing to be bound by any particular theory, formulation with fiber syrup or glucose syrup (as binding agent) reduces water activity and improves shelf life and stability.

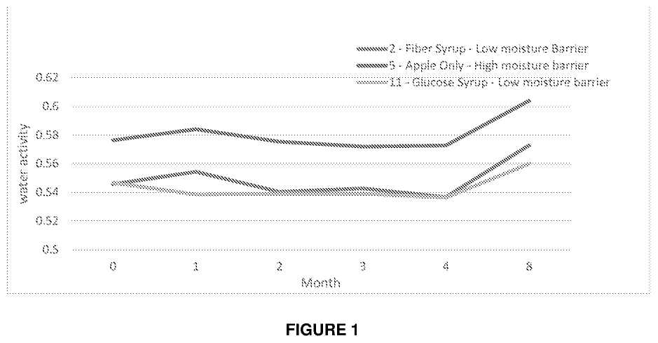

### DETAILED DESCRIPTION

Provided herein are fruit-containing confections comprising an intermediate-moisture fruit present in an amount of about 20 wt % to about 80 wt %, based on the total weight of the confection, and a binding agent. The intermediate moisture fruit has a moisture content of about 10 wt % to about 30 wt %, based on the total weight of the intermediate moisture fruit.

In the fruit-containing confections disclosed herein, partially dehydrated, semi moist fruits (intermediate-moisture fruits) are incorporated into a matrix which provides a soft, chewy texture. This overcomes the limitations of using fully dried fruits. Partially dehydrated fruits generally present technical challenges in the preparation of confections in that the product moisture and water activity is higher than a typical confection, which affects product stability parameters, such as microbial stability, flavor, and texture. The fruit-containing confections disclosed herein are stable and can be prepared with a high percentage of intermediate-moisture fruit (e.g., up to 55% fruit in the product).

In some cases, the fruit-containing confections disclosed herein comprise an intermediate-moisture fruit and have a crispy texture. The crispy texture can be achieved through various methods, including without limitation freeze drying and vacuum microwave drying. In some cases, the fruit-containing confections disclosed herein comprise additional ingredients that improve the nutritional score of the confections, e.g., protein, fiber, and/or erythritol.

### Definitions

The term “fruit” refers generally to the edible portions of fruit, e.g., fruit flesh and edible fruit skins. The products according to the disclosure generally do not contain fruit seeds or stones having maximum dimension greater than about 2 mm nor do they generally contain thick fruit peels such mango peel or apple peel. In some cases, the skin is removed from the fruit (e.g., mangos, bananas, apples, etc.). In some cases, the skin is not removed from the fruit (e.g., raspberries, strawberries, blueberries, etc.)

As used here, an “intermediate-moisture fruit” is a fruit having a moisture content from about 10 wt % to about 30 wt % based on the total weight of the fruit. Intermediate moisture fruit is also characterized by retention of naturally occurring macronutrients, such as fiber in the fruit, and prepared with minimal destruction to cell structure of the fruit. In general, intermediate moisture foods (such as intermediate moisture fruit) have suitable concentrations of dissolved solids to inhibit the growth of bacteria, molds, and yeasts and to control undesirable enzymatic activity. The intermediate-moisture fruit may be a partially dried fresh fruit, or a partially rehydrated dried fruit. Intermediate-moisture fruits can be prepared via a variety of methods, including without limitation evaporation, dehydration, freeze drying, microwave drying, and vacuum drying with or without heat. An intermediate-moisture fruit typically has 30%, 25%, 20%, 15%, or less of water, by weight (the water content ranging for example from about 15% to about 30%, or about 20% to about 30%).

The term “fruit pulp” refers to a pulp obtained by comminuting a natural, fresh fruit. The pulp may comprise a pulp that has been concentrated by evaporation or other means, to yield an intermediate-moisture fruit pulp. It will be appreciated that the fruit may have been frozen for storage and/or transport either before or after comminution to produce the pulp. Additionally, in various cases, fruit pulp may be the same as a fruit puree (as further detailed below), or alternatively is the starting material for the preparation of a fruit concentrate or a fruit paste.

“Fruit puree” is defined as chopped, homogenized fresh or frozen fruit of intermediate moisture content. No additional components have been added. It can be prepared, for example, by blending intermediate-moisture fruit or fruit pulp in a standard food processor or blender until homogeneous. The fruit may or may not include the skin of the fruit-based up the identity of the fruit and the thickness of the skin. In some cases, the skin is removed from the fruit pulp before blending (e.g., mangos, apples, bananas, etc.). In some cases, the skin is not removed from the fruit before blending (e.g., raspberries, blueberries, strawberries, etc.)

“Fruit paste” is defined as a fruit puree with most of the water content removed. The water removal is done using methods generally known in the art (e.g., heat, evaporation, or any other standard method). For example, in one particular embodiment water removal is achieved by means of heating under vacuum. Typically, the fruit paste has a consistency similar to that of thick dough.

“Fruit concentrate” is intermediate between fruit puree and fruit paste, having a higher solids concentration/lower water concentration than a fruit puree but a lower solids concentration/higher water concentration than a fruit paste, inasmuch as some of the water has been removed from the fruit puree, thereby increasing the amount of dissolved solids and sugars. Many are commercially available.

“Shelf stable” refers to a product that can be stored at typical chill cabinet temperatures of about 7° C. for a period of at least 3 months, at least 6 months, at least 9 months, at least 12 months, or more without unacceptable deterioration of organoleptic properties or appearance, or without developing microbiological activity outside regulatory limits.

“Ambient stable” refers to a product that can be stored at typical ambient temperatures, such as 20-25° C. and 60% relative humidity, for a period typically of at least 3 months, at least 6 months, at least 9 months, at least 12 months, or more without unacceptable deterioration of organoleptic properties or appearance, or without developing microbiological activity outside regulatory limits.

An “intermediate-moisture” product is defined as having between 10% and 30% moisture content by weight, and/or a water activity of from 0.5 to 0.8. Additionally, or alternatively, the product may have a water activity of greater than 0.6, greater than 0.7, or greater than 0.8, or some value in between this range (e.g., about 0.65 or about 0.75). Water activity (A_{w}) is the partial vapor pressure of water in a substance divided by the standard state partial vapor pressure of water and expressed mathematically as A_{w}=P/P₀, where P is the vapor pressure of water in the substance, and P₀ is the vapor pressure of pure water at the same temperature. In the field of food science, the standard state is defined as the partial vapor pressure of pure water at the same temperature.

The organoleptic properties of the fruit-containing confection are any properties that are associated with the taste (e.g., flavor), sight (e.g., color), smell (e.g., aroma), and/or touch (e.g., texture) of the final product.

A “binding agent” as used herein is an ingredient in the fruit-containing confection that enhances the tendency of the fruit-containing confection to maintain its integrity and/or shape. Nonlimiting examples of binding agents include fiber-based binders (e.g., soluble corn fiber or chicory root fiber), sugar-based binders (e.g., corn syrup, honey, tapioca syrup, agave syrup, glucose syrup, or brown rice syrup), polysaccharide binders (e.g., inulin syrup), starches (e.g., maltodextrin and the like), polyols (e.g., erythritol), natural gums, and hydrocolloids such as gum arabic, guar gum, agar, alginates, gum tragacanth, gelatin, and the like. Particularly contemplated are binders having no added sugars, such as polysaccharide binders (e.g., inulin syrup), starches (e.g., maltodextrin and the like), polyols (e.g., erythritol), natural gums, and hydrocolloids. In some cases, a binding agent can serve several functions in the fruit-containing confection. For example, erythritol can serve as both a binding agent and a sweetener in a fruit-containing confection disclosed herein.

As used herein, the terms “no added sugars”, “no sugars added”, and “without added sugars” are used interchangeably, and refer to fruit-containing confections adhering to the standards established by the United States FDA, the European Commission or appropriately designated regulatory agency. For example, no amount of sugars or any other ingredient that contains sugars that functionally substitute for added sugars is added during processing or packaging. Typically, these terms apply to confections if no sugar or sugar containing ingredient such as jam, jelly, or concentrated fruit juice is added during processing.

A “gum” as used herein is a confection comprising a water-soluble bulk portion, a water insoluble bulk portion and, typically, flavoring agents. The water-soluble bulk portion dissipates with a portion of the flavoring agent over a period of time during chewing. The gum base portion is retained in the mouth throughout the chew. Gum confections (e.g., chewing gums) and methods for making them are known in the art. Suitable methods for preparing gum confections are described, for example, in U.S. Pat. Pub. 2014/0308394, which is incorporated by reference in its entirety.

A “gummy” as used herein refers to confections that have a degree of elasticity sufficient to substantially reconstitute the mass of the confection after each chew. The gummy quality results from the material not readily separating during chewing, although after continuous chewing the gummy will eventually break down. Gummy confections and methods for making them are known in the art. Suitable methods for preparing gummy confections are described, for example, in U.S. Pat. Nos. 5,928,664, 4,879,108, or 4,882, 159, which are incorporated by reference in their entirety.

A “chewy candy” as used herein refers to chewy confections which are intended to be dissolved upon chewing. Chewy candy can be distinguished from other confectionery products such as chewing gums, which have insoluble components and are not intended to be dissolved upon chewing; toffees, which contain sugars and milk derivatives as the main ingredients and are characterized by a caramelization process; gummies and other hydrocolloid products, which are characterized by gelling behavior and where sugar crystallization is not desired; and jellies characterized by the lack of a gel which determines the textural character. The chewy confectionery product of the disclosure is essentially free of insoluble components and is not a toffee, gum or jelly. “Essentially free” means that there is no intentional addition of insoluble components such that the entire product is intended to be dissolved upon chewing. Chewy candies and suitable methods for preparing them are known in the art and described, for example, in U.S. Pat. No. 6,531,174, which is incorporated by reference in its entirety.

An “aerated confection” as used herein refers to a confection comprising a blend of crystallized and dissolved carbohydrates in conjunction with a whipping agent, such as egg whites, gelatin, or vegetable protein, which is aerated. By aerating the mixture, a gas such as air or nitrogen, is suspended, yielding a product that has a soft fluffy texture and reduced density characteristic of the aerated confection. An example of an aerated confection is a marshmallow. The degree of aeration will depend upon the texture desired. Aerated confections and methods for making them are known in the art. Suitable methods for preparing aerated confections are described, for example, in U.S. Pat. Nos. 4,323,588 or 4,120,987, which are incorporated by reference in their entirety.

A “chocolate” confection as used herein refers to all chocolate or chocolate-like compositions with a fat phase or fat-like composition. The term is intended, for example, to include standardized and non-standardized chocolates, i.e., including chocolates with compositions conforming to the U.S. Standards Of Identity (SOI) and compositions not conforming to the U.S. Standards Of Identity, respectively, including dark chocolate, baking chocolate, milk chocolate, sweet chocolate, semi-sweet chocolate, buttermilk chocolate, skim-milk chocolate, mixed dairy product chocolate, low fat chocolate, white chocolate, aerated chocolates, compound coatings, non-standardized chocolates and chocolate-like compositions, and the like. In the United States, chocolate is subject to a standard of identity established by the U.S. Food and Drug Administration (FDA) under the Federal Food, Drug and Cosmetic Act. Definitions and standards for the various types of chocolate are well established in the U.S. Non-standardized chocolates are those chocolates, which have compositions which fall outside the specified ranges of the standardized chocolates. Chocolate confections and methods for making them are known in the art. Suitable methods for preparing chocolate confections are described, for example, in U.S. Pat. No. 9,585,411, which is incorporated by reference in its entirety.

A “caramel” confection as used herein refers to confections that are typically prepared from a mixture of sugar, milk, fat, and optional flavorings such as vanillin. The mixture is cooked, resulting in a product that has a soft, smooth chewy texture, with a distinctive flavor. Suitable methods of cooking a caramel mixture include the use of, e.g., a scrape surface heat exchanger, an evaporator, kettle, or any other suitable means that is capable of browning and driving off moisture from the caramel mixture. Caramel confections and such suitable methods for preparing them are known in the art and described, for example, in U.S. Pat. No. 7,232,584, which is incorporated by reference in its entirety.

A “nougat” as used herein refers to confections that are typically formed by mixing a cooked sugar-based syrup and a whipping agent. The cooked sugar-based syrup is often made using a combination of sucrose and corn syrup. The whipping agent may be protein based, e.g., milk-, egg-, or soy protein-based. The cooked sugar-based syrup is combined with the whipping agent, as the mixture is aerated and mixed to make a frappe. Nougat is formed by adding to that frappe a flavoring/coloring slurry which can be a fat or aqueous suspension, solution, or dispersion. By aerating the mixture, a gas such as air or nitrogen, is suspended, yielding a product that has a soft fluffy texture and reduced density characteristic of nougat. The degree of aeration will depend upon the texture desired. Nougat confections and suitable methods for preparing them are known in the art and described, for example, in U.S. Pat. No. 7,232,584, which is incorporated by reference in its entirety.

A “taffy” as used herein refers to confections made by stretching or pulling a sticky mass of boiled sugar, butter or vegetable oil, flavorings, and colorings, until it becomes aerated (tiny air bubbles produced), resulting in a light, fluffy and chewy candy. Taffy confections and suitable methods for preparing them are known in the art and described, for example, in U.S. Pat. No. 4,317,839, which is incorporated by reference in its entirety.

A “licorice confection” as used herein refers to a soft, chewy candy of a prescribed texture and does not necessarily have to include licorice as a flavoring agent. The term licorice confection, as used in the art, refers not to the flavor of the confection but to the soft, chewy texture of the confection. For example, it is possible to have licorice confections which contain no licorice whatever, but instead contain a variety of other natural or artificial flavoring agents such as, for example, chocolate, strawberry, or spearmint. Licorice confections and suitable methods for preparing them are known in the art and described, for example, in U.S. Pat. No. 3,806,617, which is incorporated by reference in its entirety.

### Fruit-Containing Confections

Provided herein are fruit-containing confections comprising: an intermediate-moisture fruit present in an amount of about 20 wt % to about 80 wt %, based on the total weight of the confection; and a binding agent, wherein the intermediate moisture fruit has a moisture content of about 10 wt % to about 30 wt %, based on the total weight of the intermediate moisture fruit.

The fruit-containing confections may be prepared without the addition of refined sugar or artificial sweetener. In some cases, the binding agent has no added sugars.

The fruit-containing confections of the disclosure can comprise intermediate-moisture fruit based on a wide variety of fruits including, but not limited to, acai berries, apple, apricot, avocado, banana, blackberry, black currant, blueberry, boysenberry, cantaloupe, currant, cherry, cloudberry, coconut, cranberry, date, dragon fruit, elderberry, fig, goji berry, gooseberry, grapes, raisin, grapefruit, guava, huckleberry, jackfruit, jujube, juniper berry, kiwi, kumquat, lemon, lime, lychee, mandarin, mango, marion berry, melon, cantaloupe, honeydew, miracle fruit, mulberry, nectarine, olive, orange, blood orange, clementine, tangerine, papaya, passion fruit, peach, pear, persimmon, plum/prune, pineapple, pumpkin, pomegranate, pomelo, purple mangosteen, quince, raspberry, salmon berry, black raspberry, red currant, star fruit, strawberry, squash, tamarillo, tomato, ugli fruit, watermelon and mixtures thereof. In some cases, the intermediate-moisture fruit comprises apple, apricot, banana, blueberry, cherry, cranberry, date, fig, mango, peach, pear, pineapple, prune, raisin, and/or strawberry. In some cases, the intermediate-moisture fruit comprises apple. In some cases, the fruit-containing confection comprises one type of intermediate-moisture fruit. In some cases, the fruit-containing confection comprises more than one type of intermediate-moisture fruit.

The fruit-containing confections disclosed herein comprise intermediate-moisture fruits and overcome many of the undesirable properties of confections comprising fully dried fruits, while maintaining pleasing organoleptic and manufacturing properties. While intermediate-moisture fruits contain more water than fully dried fruits, the fruit-containing confection is within appropriate safe antimicrobial limits as determined by the United States FDA, the European Commission or appropriately designated regulatory agency.

In some cases, intermediate-moisture fruit is preferred for preparing the fruit-containing confections disclosed herein. The intermediate-moisture fruit can comprise a variety of forms, such as previously frozen fruit, canned fruit, partially dehydrated or rehydrated fruit, as well as frozen concentrates, pastes, purees, fruit byproducts, fruit pulps and combinations thereof.

While the present disclosure is primarily directed towards fruit containing confections, the skilled artisan will appreciate that the present disclosure is equivalently applicable to all edible plant solids, including, but not limited to, vegetables.

Typically, the fruit-containing confection comprises an intermediate-moisture fruit in an amount of about 20 wt % to about 80 wt %, based on the total weight of the confection. In some cases, the fruit-containing confection comprises the intermediate-moisture fruit in an amount of about 20%, about 25%, about 30%, about 35%, about 40%, about 45%, about 50%, about 55%, about 60%, about 65%, about 70%, about 75%, or about 80% by weight. In some cases, the fruit-containing confection comprises the intermediate-moisture fruit in an amount of about 55% to about 70%. In some cases, the fruit-containing confection comprises the intermediate-moisture fruit in an amount of about 55%. In some cases, the fruit-containing confection comprises the intermediate-moisture fruit in an amount of about 60%. In some cases, the fruit-containing confection comprises the intermediate-moisture fruit in an amount of about 65%. In some cases, the fruit-containing confection comprises the intermediate-moisture fruit in an amount of about 70%.

The intermediate-moisture fruits disclosed herein have a moisture content of about 10 wt % to about 30 wt %, based on the total weight of the intermediate-moisture fruit. In some cases, the intermediate-moisture fruits have a moisture content of about 10 wt %, about 12 wt %, about 14 wt %, about 16 wt %, about 18 wt %, about 20 wt %, about 22 wt %, about 24 wt %, about 26 wt %, about 28 wt %, or about 30 wt %. In some cases, the intermediate-moisture fruit has a moisture content of about 12 wt % to about 18 wt %, based on the total weight of the intermediate-moisture fruit. In some cases, the intermediate-moisture fruit has a moisture content of about 12 wt %, about 13 wt %, about 14 wt %, about 15 wt %, about 16 wt %, about 17 wt %, or about 18 wt %.

The intermediate-moisture fruits disclosed herein have a sugar content of 50 wt % or less, based on the total weight of the intermediate-moisture fruit. In some cases, the intermediate-moisture fruits have a sugar content of about 5 wt %, about 10 wt %, about 15 wt %, about 20 wt %, about 25 wt %, about 30 wt %, about 35 wt %, about 40 wt %, about 45 wt %, or about 50 wt %. In some cases, the intermediate-moisture fruits have a sugar content of about 20 wt % to about 40 wt %. In some cases, the intermediate-moisture fruits have a sugar content of about 20 wt %, about 22 wt %, about 24 wt %, about 26 wt %, about 28 wt %, about 30 wt %, about 32 wt %, about 34 wt %, about 36 wt %, about 38 wt %, or about 40 wt %.

In some cases, the binding agent is a fiber-based binder, a sugar-based binder, inulin syrup, maltodextrin, a polyol, or a combination thereof. In some cases, the binding agent is a fiber-based binder. In some cases, the fiber-based binder is soluble corn fiber, chicory root fiber, or a combination thereof. In some cases, the binding agent is a sugar-based binder. In some cases, the sugar-based binder is honey, tapioca syrup, agave syrup, brown rice syrup, or a combination thereof. In some cases, the binding agent is inulin syrup. In some cases, the binding agent is maltodextrin. In some cases, the binding agent is a polyol. In some cases, the polyol is erythritol.

In some cases, the binding agent is present in an amount of about 10 wt % to about 20 wt %, based on the total weight of the confection. In some cases, the binding agent is present in an amount of about 10 wt %, about 12 wt %, about 14 wt %, about 15 wt %, about 16 wt %, about 18 wt %, or about 20 wt %.

As previously noted, the fruit-containing confections disclosed herein are advantageously stable. The fruit-containing confections are shelf stable, ambient stable, or both. As a result, the fruit-containing confections disclosed herein have many of the benefits or properties of the natural fruit from which they are derived or prepared, but they may be stored for a much longer period of time. For example, in some cases, the fruit-containing confection may be shelf stable, ambient stable or both for at least 3 months, at least 6 months, at least 9 months, at least 12 months, or more. In some cases, the fruit-containing confection is shelf stable, ambient stable or both for at least 3 months. In some cases, the fruit-containing confection is shelf stable for at least 3 months. In some cases, the fruit-containing confection is ambient stable for at least 3 months. In some cases, the fruit-containing confection is both shelf stable and ambient stable for at least 3 months. In some cases, the fruit-containing confection is shelf stable, ambient stable or both for at least 6 months. In some cases, the fruit-containing confection is shelf stable for at least 6 months. In some cases, the fruit-containing confection is ambient stable for at least 6 months. In some cases, the fruit-containing confection is both shelf stable and ambient stable for at least 6 months. In some cases, the fruit-containing confection is shelf stable, ambient stable or both for at least 9 months. In some cases, the fruit-containing confection is shelf stable for at least 9 months. In some cases, the fruit-containing confection is ambient stable for at least 9 months. In some cases, the fruit-containing confection is both shelf stable and ambient stable for at least 9 months. In some cases, the fruit-containing confection is shelf stable, ambient stable or both for at least 12 months. In some cases, the fruit-containing confection is shelf stable for at least 12 months. In some cases, the fruit-containing confection is ambient stable for at least 12 months. In some cases, the fruit-containing confection is both shelf stable and ambient stable for at least 12 months. In some cases, the fruit-containing confection is shelf stable, ambient stable or both for more than 12 months. In some cases, the fruit-containing confection is shelf stable for more than 12 months. In some cases, the fruit-containing confection is ambient stable for more than 12 months. In some cases, the fruit-containing confection is both shelf stable and ambient stable for more than 12 months.

In some cases, the fruit-containing confection further comprises one or more optional auxiliary agents comprising an acidulant, a flavor agent, a preservative, a color agent, an herb, a seed, a vitamin, an oil, a saturated fat or an unsaturated fat, pectin, a protein, and/or combinations thereof. In some cases, the fruit-containing confection further comprises pectin. The auxiliary agent or agents can be selected to give the fruit-containing confection a suitable organoleptic profile. In some cases, the auxiliary agent is present in an amount of about 1 wt % to about 10 wt %, based on the total weight of the fruit-containing confection.

In some cases, the fruit-containing confections disclosed herein comprise an acidulant. An acidulant may be an edible organic acid added in sufficient amounts to provide the composition with a pH of about less than 4.5, less than 4.2, less than 4.0, or less than 3.7. The particular pH selected from within this pH range may depend in part upon the type of fruit used and/or the organoleptic profile desired in the fruit-containing confection. For example, satisfactory results may be obtained when the acidulant is present at levels ranging from about 0.01 wt % to about 2.0 wt % based on the total weight of the fruit-containing confection. In some cases, the acidulant is present at a level from about 0.1 wt % to about 2 wt %. In some cases, the acidulant is present at a level from about 0.1 wt % to about 1 wt %. In some cases, the acidulant is present at a level from about 0.1 wt % to about 0.6 wt %. In some cases, the acidulant is present at a level from about 0.2 wt % to about 0.4 wt %. In some cases, the acidulant is present at a level of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt %. In some cases, the acidulant is present at a level of about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2 wt %.

A variety of edible organic acids can be used as the acidulant to adjust the pH of the fruit-containing confection as well as to modify the taste and tartness of the fruit-containing confection. Examples of suitable acids for use herein include, but are not limited to, acetic acid, citric acid, tartaric acid, malic acid, lactic acid, fumaric acid, ascorbic acid and mixtures thereof, especially in the form of the sodium, potassium and/or calcium salts thereof.

In some cases, the fruit-containing confections disclosed herein comprise a flavor agent to give the fruit-containing confection a suitable organoleptic profile. The flavor may come from natural sources in any physical form, including, but not limited to, a solid, a powder, an oil, a liquid, a concentrate, a paste, a puree, or any combination thereof. The flavor is any flavor used in food products. The amount of flavor agent is determined empirically based on the desired organoleptic profile of the fruit-containing confection. In some cases, the flavor agent is the same type as the base fruit. In some cases, the flavor agent is different from the base fruit. In some cases, no additional flavor agent is added.

The fruit-containing confection in various cases advantageously has no added sugars, and in some cases, comprises no refined sugar or other sweeteners (e.g., artificial sweeteners) added. Alternatively, the fruit-containing confection may further comprise supplemental sweeteners such as, but not limited to, saccharine, aspartame, thaumatin, potassium acetylsulfame, sucralose, and mixtures thereof without departing from the scope of the disclosure. In some cases, the amount of the sweetener is determined empirically based on the desired organoleptic profile of the fruit-containing confection. In some cases, the fruit-containing confection has no added sugars. In some cases, the fruit-containing confection is free of sugar-based binding agents and/or syrups.

In some cases, the fruit-containing confections disclosed herein comprise a preservative to promote stability. For example, the preservative can be an antioxidant. A suitable antioxidant is ascorbic acid, which may also function as an acidulant or nutritional supplement. In some cases, the preservative is present in an amount from about 0.1 wt % to about 4 wt % based on the total weight of the fruit-containing confection. In some cases, the preservative is present in an amount from about 0.1 wt % to about 2 wt %. In some cases, the preservative is present in about 0.1 wt %, about 0.5 wt %, about 1 wt %, about 1.5 wt %, about 2 wt %, about 2.5 wt %, about 3 wt %, about 3.5 wt %, or about 4 wt %. In some cases, the preservative is present in or derived from another ingredient in the fruit-containing confection. For example, ascorbic acid may be derived from natural fruit in the confection.

In some cases, the fruit-containing confections disclosed herein comprise a color agent. Typically, the color agent may be selected so as to give the final product a color that is most closely associated with the fruit material from which the fruit-containing confection is derived or prepared. In some cases, the color agent is selected to impart a specific color to the fruit-containing confection based on specific criteria, such as, but not limited to, product marketing or consumer appeal. In some cases, no additional color agent is added. A non-limiting example of a color agent is black carrot extract.

In some cases, the fruit-containing confections disclosed herein comprise an herb. In some cases, the herb is cinnamon, spearmint, or peppermint.

In some cases, the fruit-containing confections disclosed herein comprise a seed. In some cases, the seed is sesame seed, chia seed, or strawberry seed.

In some cases, the fruit-containing confections disclosed herein comprise a vitamin. Nonlimiting examples of vitamins include vitamin A, vitamin C (ascorbic acid), vitamin B1 (thiamine), vitamin B2 (riboflavin), vitamin B3 (niacinamide), vitamin B5 (pantothenic acid), vitamin B6 (pyridoxine HCl), vitamin B12 (cobalamin), vitamin D (cholecalciferol), vitamin E, vitamin K (phytonadione), biotin, choline, niacin, folic acid, and combinations thereof. Other nutrients can be added, such as calcium, chromium, copper, ginseng, and combinations thereof. In some cases, a vitamin can serve as an additive in another category simultaneously. For example, ascorbic acid can be an acidulant, a preservative, and a vitamin.

In some cases, the fruit-containing confections disclosed herein comprise an oil. In some cases, the oil comprises vegetable oil, olive oil, sunflower oil, palm oil, orange oil, or peppermint oil.

In some cases, the fruit-containing confections disclosed herein comprise a saturated fat or an unsaturated fat. In some cases, the saturated fat or unsaturated fat is sunflower oil or cocoa butter. In some cases, the saturated fat or unsaturated fat is present in an amount of about 1 wt % to about 4 wt % based on the total weight of the fruit-containing confection. In some cases, the saturated fat or unsaturated fat is present in about 1 wt %, about 1.5 wt %, about 2 wt %, about 2.5 wt %, about 3 wt %, about 3.5 wt %, or about 4 wt %.

In some cases, the fruit-containing confections disclosed herein comprise a protein. In some cases, the protein comprises whey, fava bean protein, pea protein, canola protein, or barley protein isolate.

In some cases, the fruit-containing confection is a snack bar, a fruit snack, a gum, a gummy, a chewy candy, an aerated confection, chocolate confection, caramel confection, taffy, nougat, licorice confection, or coated confection. In some cases, the fruit-containing confection is a snack bar. In some cases, the fruit-containing confection is a fruit snack. In some cases, the fruit-containing confection is a gum. In some cases, the fruit-containing confection is a gummy. In some cases, the fruit-containing confection is a chewy candy. In some cases, the fruit-containing confection is an aerated confection. In some cases, the fruit-containing confection is a chocolate confection. In some cases, the fruit-containing confection is a caramel confection. In some cases, the fruit-containing confection is a taffy. In some cases, the fruit-containing confection is a nougat. In some cases, the fruit-containing confection is a licorice confection. In some cases, the fruit-containing confection is a coated confection. In some cases, the fruit-containing confection is suitable for packaging in single or multiple serving sizes.

In some cases, the fruit-containing confections disclosed herein have an appealing texture. In some cases, the fruit-containing confections have a crispy texture.

Because the disclosure relates to fruit-containing confections intended for human consumption, all ingredients, additives and other additions to any fruit-containing confection or used in any method are generally regarded as safe (GRAS) as designated by the United States FDA or FEMA GRAS as designated by the International Flavor and Manufacturing Association.

In some cases, the fruit-containing confections disclosed herein may be 100% organic as defined by the US Department of Agriculture, the European Commission or appropriate certifying organization. The fruit-containing confections can be substantially or completely free of artificial food additives. In some cases, the fruit-containing confection comprises 100% all-natural ingredients.

### Methods of Preparation

Provided herein are methods of making the fruit-containing confections disclosed herein comprising: drying fresh fruit under conditions sufficient to provide the intermediate-moisture fruit having a moisture content of about 10 wt % to about 30 wt %, based on the total weight of the intermediate-moisture fruit; and, admixing the intermediate-moisture fruit with the binding agent.

In general, the various ingredients as set forth above, including a suitable source of intermediate-moisture fruit material (e.g., a pulp, paste, puree, and/or concentrate) is admixed with a suitable binding agent. In some cases, the mixture of intermediate-moisture fruit and binding agent is subjected to a suitable pressure and/or heat process that does not undesirably alter (e.g., cook) one or more of the organoleptic properties and/or the nutritional value of the base fruit. In some cases, the source of the base fruit is a fruit paste. In some cases, the mixture is exposed to a pressure and/or heat process, for example, but not limited to, microwave or conventional heating conditions, to provide the fruit-containing confection. Such process will render the fruit-containing confection commercially sterile. The fruit-containing confection may be packaged either before or after processing. The final product is a fruit-containing confection composition suitable for packaging in single or multiple serving sizes.

In accordance with the present process, in some cases, the base fruit is comminuted to a pulp. Any fruit as described above is encompassed herein. As is known in the art, the skin of a fruit, vegetable or nut may or may not be edible or favored by consumers of the fruit-containing confection. In some cases the skin of the base fruit is removed before comminuting. In other cases the skin of the base fruit is not removed before comminuting. The pulp may be comminuted into a substantially smooth puree or it may be a more loosely chopped pulp (e.g. containing, for example, pieces larger than about 1 mm maximum dimension, for example, pieces having maximum dimensions of from about 1 mm to about 5 mm). The resulting comminuted material may be a mixture of smooth puree and larger pieces. The inclusion of some fruit pieces in the puree can provide a non-uniform or granular texture in the fruit-containing confection that may be preferred by consumers. In some cases, the pulp is a whole pulp wherein none of the components of the flesh of the base material are removed before subsequent processing steps. In some cases, the moisture content of the comminuted material is substantially the same as the moisture content of the intermediate-moisture fruit from which it was obtained. Typically, intermediate-moisture fruit pulp has a water content of less than about 30 wt %, e.g., from about 10% to about 30% water. As is recognized in the art, different fruit pulps and purees will have a different moisture composition. In some cases, the water content of the pulp may be reduced by methods known in the art, including for example, but not limited to, evaporation, heating and/or reduced pressure, under conditions that will not have an unwanted effect on the organoleptic properties of the fruit-containing confection.

Typically, the step of comminuting the base fruit to form the pulp is performed at temperatures below about 50° C., or below about 40° C. (e.g., at ambient temperature). Conditions are selected such as to substantially retain most or all of the natural organoleptic profile and/or nutritional value of the base fruit.

In some cases, the mixture may be prepared comprising, or alternatively consisting essentially of, a pulp, a puree, a paste, and/or a concentrate (as defined herein) of the base fruit and optionally one or more additional ingredients detailed herein. Any fruit as described above or included in the Examples below is encompassed herein. In some cases, the mixture comprises about 20-80 wt. % of an intermediate-moisture fruit paste, with the balance being made up of the binding agent and any other optional ingredients recited herein. In some cases, the mixture comprises about 20-80 wt. % of an intermediate-moisture fruit puree, with the balance being made up of the binding agent and any other optional ingredients recited herein.

In some cases, additional optional ingredients may be added to the base fruit and binding agent prior to comminuting as previously noted. These optional ingredients may be one or more auxiliary agents selected from an acidulant, a flavor agent, a preservative, a color agent, an herb, a seed, a vitamin, an oil, a saturated fat or an unsaturated fat, pectin, a protein, and/or combinations thereof. These optional ingredients are described elsewhere herein and are typically selected to give the fruit-containing confection a specific organoleptic profile and/or nutritional benefit. Alternatively, one or more of these optional ingredients may be added after comminuting to form a mixture just prior to exposing the mixture to the pressure and/or heat process.

The process according to the present disclosure comprises blending the ingredients into a smooth or semi-smooth mixture prior to processing under a pressure and/or heat process, typically, for example, ultra-high pressure (UHP) or electromagnetic radiation. Blending is done in an apparatus of appropriate size ranging from a standard commercial food processor or blender to prepare, for example prototype or pilot batches, to a large industrial scale high-shear blender (e.g., production and commercial batches). These techniques are well known in the art.

In some cases, the fruit-containing confection is further dried after mixing. In some cases, the fruit-containing confection is dried via freeze-drying, microwave-drying, or vacuum-drying. In some cases, the fruit-containing confection is dried via freeze-drying. In some cases, the fruit-containing confection is dried via microwave-drying. In some cases, the fruit-containing confection is dried via vacuum-drying.

### EXAMPLES

### Example 1

### No Added Sugar Intermediate-Moisture Apple Confection

A no added sugar intermediate-moisture apple confection was prepared as described herein.

No added sugar formula

| | % |
|---|---|
| Intermediate Moisture apple | 70 |
| Soluble corn Fiber | 15 |
| Erythritol | 10 |
| Pectin | 3 |
| Sunflower oil | 1.1 |
| Citric acid | 0.6 |
| Malic Acid (BIGMAC) | 0.3 |

### Example 2

### Fruit-Forward Chew With Added Sugar

A fruit-forward chew confection with added sugar was prepared as described herein.

Fruit forward chew with added sugar

| | % |
|---|---|
| Intermediate Moisture apple | 55 |
| Soluble corn Fiber | 12 |
| Corn syrup | 27 |
| Pectin | 1 |
| Palm oil | 4 |
| Citric acid | 0.7 |
| Malic Acid (BIGMAC) | 0.3 |

### Example 3

### Apple Chewing Gum With No Added Sugar

An apple-containing chewing gum with no added sugar was prepared as described herein.

Apple chewing gum with no added sugar

| | % |
|---|---|
| Treetop Apple wedges | 61.25 |
| Gum Base | 37 |
| Citric acid | 0.50 |
| Malic Acid | 0.25 |
| Flavor | 1 |

1. A fruit-containing confection comprising:
an intermediate-moisture fruit present in an amount of about 20 wt % to about 80 wt %, based on the total weight of the fruit-containing confection; and
a binding agent,
wherein the intermediate-moisture fruit has a moisture content of about 10 wt % to about 30 wt %, based on the total weight of the intermediate-moisture fruit.

2. The fruit-containing confection of claim 1, wherein the intermediate-moisture fruit comprises apple, apricot, banana, blueberry, cherry, cranberry, date, fig, mango, peach, pear, pineapple, prune, raisin, and/or strawberry.

3. The fruit-containing confection of claim 2, wherein the intermediate-moisture fruit comprises apple.

4. The fruit-containing confection of claim 1, wherein the intermediate-moisture fruit has a moisture content of about 12 wt % to about 18 wt %, based on the total weight of the intermediate-moisture fruit.

5. The fruit-containing confection of claim 1, wherein the binding agent is a fiber-based binder, inulin syrup, maltodextrin, a polyol, or a combination thereof.

6. The fruit-containing confection of claim 5, wherein the fiber-based binder is soluble corn fiber, chicory root fiber, or a combination thereof.

7. The fruit-containing confection of claim 5, wherein the polyol is erythritol.

8. The fruit-containing confection of claim 1, wherein the binding agent is a sugar-based binder.

9. The fruit-containing confection of claim 8, wherein the sugar-based binder is honey, tapioca syrup, agave syrup, brown rice syrup, glucose syrup, or a combination thereof.

10. The fruit-containing confection of claim 1, wherein the fruit-containing confection has no added sugars.

11. The fruit-containing confection of claim 10, wherein the fruit-containing confection is free of sugar-based binding agents and/or syrups.

12. The fruit-containing confection of claim 10, wherein the binding agent has no added sugars.

13. The fruit-containing confection of claim 1, wherein the binding agent is present in an amount of about 10 wt % to about 20 wt %, based on the total weight of the fruit-containing confection.

14. The fruit-containing confection claim 1, wherein the fruit-containing confection is stable for at least 9 months.

15. The fruit-containing confection of claim 1, wherein the fruit-containing confection further comprises an auxiliary agent comprising an acidulant, a flavor agent, a preservative, a color agent, an herb, a seed, a vitamin, an oil, a saturated fat, an unsaturated fat, pectin, a protein, or a combination thereof.

16. The fruit-containing confection of claim 15, wherein the auxiliary agent is present in an amount of about 1 wt % to about 10 wt %, based on the total weight of the fruit-containing confection.

17. The fruit-containing confection of claim 16, wherein the auxiliary agent comprises a saturated fat or an unsaturated fat present in an amount of about 1 wt % to about 4 wt %.

18. The fruit-containing confection of claim 16, wherein the auxiliary agent comprises an acidulant present in an amount of about 0.01 wt % to about 2 wt %.

19. The fruit-containing confection of claim 1, wherein the fruit-containing confection is a snack bar, a fruit snack, a gum, a gummy, a chewy candy, an aerated confection, chocolate confection, caramel confection, taffy, nougat, licorice confection, or coated confection.

20. The fruit-containing confection of claim 1, having a crispy texture.

21. A method of making the fruit-containing confection of claim 1, comprising: admixing the intermediate-moisture fruit with the binding agent.

22. The method of claim 21, wherein the fruit-containing confection is dried via freeze-drying, microwave-drying, or vacuum-drying.
